(19) United States
(12) Patent Application Publication
(10) Pub. No.: US 2020/0230833 A1
(43) Pub. Date: Jul. 23, 2020

(54) SHAVING CARTRIDGE

(71) Applicant: BIC VIOLEX S.A., Anoixi (GR)

(72) Inventors: Ioannis BOZIKIS, KOUKAKI ATHENS (GR); Spiros GRATSIAS, KYPSELI ATHENS (GR)

(21) Appl. No.: 16/482,950

(22) PCT Filed: Feb. 1, 2018
(86) PCT No.: PCT/EP2018/052475

§ 371 Date: Aug. 1, 2019

Related U.S. Application Data
(60) Provisional application No. 62/453,778, filed on Feb. 2, 2017.

(51) Int. Cl. B26B 21/40; B26B 21/44

(52) U.S. Cl. CPC B26B 21/4018; B26B 21/521; B26B 21/443

(57) ABSTRACT

A shaving cartridge includes a housing extending along a longitudinal axis. The housing has a top side, a bottom side opposite to the top side, at least one longitudinal wall, and first and second side walls. The shaving cartridge also includes at least one shaving blade and a customizing tool. The customizing tool is coupled to the housing. The customizing tool includes an upper surface extending external to the at least one longitudinal wall of the housing. The customizing tool includes a side surface extends at an angle from the upper surface and is proximate to the longitudinal wall of the housing and external ends of the first and second side walls. The customizing tool extends from the at least one longitudinal wall or is attached to at least one of the side walls.

### CROSS REFERENCE TO RELATED APPLICATION

This application is a National Stage application of International Application No. PCT/EP2018/052475, filed on Feb. 1, 2018, now published as WO2018/141829 and which claims priority to U.S. 62/453,778, filed Feb. 2, 2017, the entire contents of which is incorporated herein by reference.

### BACKGROUND

### 1. Field

The following description relates to shaving razors. A shaving razor may include a cartridge with one or more components which include a cap, shaving blades, and a customizing tool. For example, a shaving razor may include a head with a customizing tool which is provided in place of a guard bar and extends the contact surface of the cartridge.

### 2. Description of Related Art

Shaving razors include cartridges which contain components such as shaving blades, lubrication means, guard bars, covers, and trimming blades. The cartridges may not provide a large footprint for skin contact. As such, the skin, during shaving, may not be sufficiently stretched, and less skin and hair contacts with the cartridge and shaving blades during each shaving stroke. Further, the guard bar may include fins or projections which are provided to help stretch the skin, but the cartridge does not sufficiently glide along the skin.

Further, in the conventional shaving razors it is common practice for the guard bar to be securely attached onto the cartridge, thus excluding the possibility for the user to choose customizable solutions on the guard bar area, adapted to his desires and needs.

### SUM MARY

The present concept provides a shaving cartridge that overcomes the aforementioned disadvantages of conventional shaving cartridges. The shaving cartridge of the present concept generally includes a housing, at least one shaving blade and a customizing tool. The shaving cartridge may further include at least one component which may include at least a further shaving blade, a cap, at least one retaining means, at least one lubrication means which can include any type of strip or lubrication means that provide a low-friction effect. The customizing tool may be coupled with and extend from the housing. The customizing tool may expand the contact surface of the cartridge in two directions: (i) parallel to the axis of the shaving plane, where the customizing tool includes a top surface that covers the guard bar position in conventional shaving cartridges and lateral sides adjacent to the external side of the housing, and (ii) perpendicularly to the axis of the shaving plane, where the customizing tool provides a side surface which embraces the external side of the shaving cartridge and slightly bends in the bottom side of the shaving cartridge. Here, the axis of the shaving plane is the axis along which the shaver is moved for performing shaving.

The aforementioned may be achieved in aspects of the present concept by providing a shaving cartridge. The shaving cartridge may include a housing extending along a longitudinal axis. The housing may have a top side and a bottom side opposite to the top side. The housing may also have at least one longitudinal wall (first longitudinal wall) and first and second side walls. The at least one longitudinal wall may extend between the top and bottom side of the housing. The first and second side walls may each extend from the at least one longitudinal wall. The housing may have a first and a second longitudinal wall and a first and a second side walls. The first and second side walls may extend between the first and second longitudinal walls. A customizing tool may be coupled with the housing. The customizing tool may extend from the at least one longitudinal wall or may be attached to at least one of the side walls. The shaving cartridge may include at least one shaving blade. The customizing tool may be coupled with and may extend from the top side of the housing. The customizing tool may include an upper surface which may extend substantially along the shaving plane and may extend external to the second longitudinal wall of the housing. The customizing tool may also include a side surface which may extend at an angle from the upper surface and may be proximate to the second longitudinal wall of the housing and external ends of the first and second side walls. In other embodiments, the customizing tool may be removably coupled onto the at least one longitudinal wall.

The shaving cartridge may further include at least one component. The at least one component may further include more shaving blades so as to include one, two, three, four, five or more shaving blades, a cap, at least one retaining means, at least one lubrication means, and/or a combination thereof.

The customizing tool may further include a lower surface which may be proximate to the bottom side of the at least one longitudinal wall.

At least one of the upper surface and side surface of the customizing tool may bear configurations which include ribs, fins, filaments, lubrication coating, and/or protrusions.

The lower surface of the customizing tool may bear a configuration which includes ribs, fins, filaments, lubrication coating, and/or protrusions.

The customizing tool may be coupled with the housing by at least one of a snap fit mechanism, a hook mechanism, a press fit mechanism, a twist mechanism, or a screw mechanism.

The upper surface of the customizing tool may include at least one protrusion which corresponds with recesses in the top surface of the at least one longitudinal wall to couple the customizing tool with the housing.

The width of the upper surface of the customizing tool may be in the range from about 3 mm to about 6 mm. The width of the side surface of the customizing tool may be in the range from about 0.5 mm to about 7 mm.

The customizing tool may be removably coupled with the housing.

The shaving cartridge may further include a guard bar. The customizing tool may be coupled with the guard bar or a guard bar may be embedded as part of the customizing tool

The upper surface and the side surface of the customizing tool may be homogenous without patterns.

The upper surface of the customizing tool may include lubricating portions.

The customizing tool may be attached to the side walls of the housing by any suitable means, such as snap fit mechanism.

The upper and side surface of the customizing tool may be of any shape, for example a line, an arc, or a spline.

The side surface of the customizing tool may have or be a porous material.

At least a portion of the customizing tool may be made of at least one of metal, plastic, rubber, wood, paper, and glass.

The shaving cartridge may further comprise a connecting portion configured to couple the shaving cartridge to a handle.

The first and second longitudinal walls may each extend longitudinally along the longitudinal axis between the top and bottom sides.

The customizing tool may extend from the top side of the housing substantially perpendicular to the longitudinal axis.

### BRIEF DESCRIPTION OF THE DRAWINGS

The foregoing summary, as well as the following detailed description, will be better understood when read in conjunction with the appended drawings. For the purpose of illustration, there are shown in the drawings certain embodiments of the present disclosure. It should be understood, however, that the present concept is not limited to the precise embodiments and features shown. The accompanying drawings, which are incorporated in and constitute a part of this specification, illustrate an implementation of apparatuses consistent with the present concept and, together with the description, serve to explain advantages and principles consistent with the present concept.

FIG. 1 is a diagram illustrating a perspective view of an exemplary shaving cartridge.

FIG. 2 is a diagram illustrating a perspective view of an exemplary customizing tool.

FIG. 3 is a diagram illustrating a cross-sectional view III-III of the exemplary shaving cartridge.

FIG. 4 is a diagram illustrating a perspective view of another exemplary shaving cartridge.

FIG. 5 is a view of an exemplary customizing tool of the shaving cartridge of FIG. 4, seen in the direction V.

FIG. 6 is a cross-sectional view VI-VI of the exemplary shaving cartridge of FIG. 4.

FIG. 7 is a diagram illustrating a perspective view of another exemplary shaving cartridge.

FIG. 8 is a view of an exemplary customizing tool of the shaving cartridge of FIG. 7, seen in the direction VIII.

FIG. 9 is a cross-sectional view IX-IX of the exemplary shaving cartridge of FIG. 7.

FIG. 10 is a diagram illustrating a perspective view of another exemplary shaving cartridge.

FIG. 11 is a view of an exemplary customizing tool of the shaving cartridge of FIG. 10, seen in the direction XI.

FIG. 12 is a cross-sectional view XII-XII of the exemplary shaving cartridge of FIG. 10.

### DETAILED DESCRIPTION

It is to be understood that the present concept is not limited in its application to the details of construction and to the embodiments of the components set forth in the following description or illustrated in the drawings. The figures and written description are provided to teach any person skilled in the art to make and use the concepts for which patent protection is sought. The present concept is capable of other embodiments and of being practiced and carried out in various ways. Persons of skill in the art will appreciate that the development of an actual commercial embodiment incorporating aspects of the present concept will require numerous implementations—specific decisions to achieve the ultimate goal of the developer for the commercial embodiment. While these efforts may be complex and time-consuming, these efforts, nevertheless, would be a routine undertaking for those of skill in the art of having the benefit of this disclosure.

I. Terminology

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the present concept or the appended claims. Further, it should be understood that any one of the features of the present concept may be used separately or in combination with other features. Other systems, methods, features, and advantages of the present concept will be, or become, apparent to one with skill in the art upon examination of the figures and the detailed description. It is intended that all such additional systems, methods, features, and advantages be included within this description, be within the scope of the present concept and be protected by the accompanying claims.

Further, any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface. Similarly, the terms “about” or “approximately,” as used in the description and the appended claims, should be understood to include the recited values or a value that is three times greater or one third of the recited values.

Further, as the present concept is susceptible to embodiments of many different forms, it is intended that the present disclosure be considered as an example of the principles of the present concept and not intended to limit the present concept to the specific embodiments shown and described. Any one of the features of the present concept may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments but is not necessarily included. Thus, the present concept may include a variety of combinations and/or integrations of the embodiments described herein. Additionally, all aspects of the present disclosure, as described herein, are not essential for its practice. Likewise, other systems, methods, features, and advantages of the present concept will be, or become, apparent to one with skill in the art upon examination of the figures and the description. It is intended that all such additional systems, methods, features, and advantages be included within this description, be within the scope of the present concept and be encompassed by the claims.

Lastly, the terms “or” and “and/or,” as used herein, are to be interpreted as inclusive or meaning any one or any combination. Therefore, “A, B or C” or “A, B and/or C” mean any of the following: “A,” “B,” “C”; “A and B”; “A and C”; “B and C”; “A, B and C.” An exception to this definition will occur only when a combination of elements, functions, steps or acts are in some way inherently mutually exclusive.

II. General Architecture

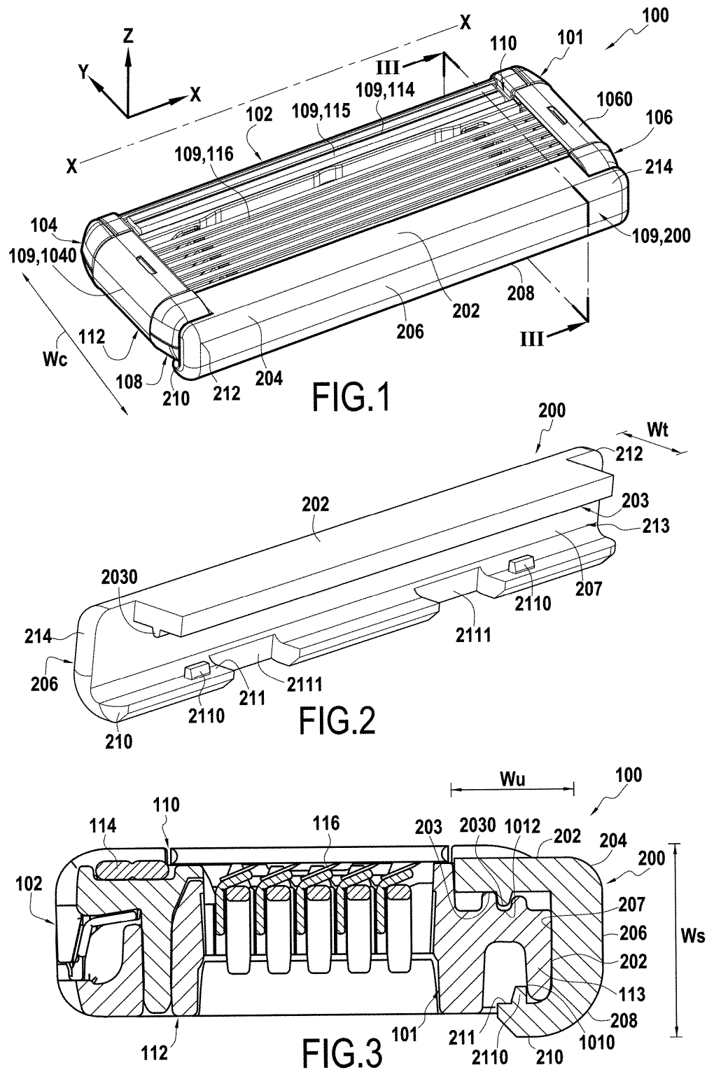

FIGS. 1 and 3 illustrate an exemplary shaving cartridge 100. The shaving cartridge 100 can be coupled with a handle (not shown). The handle can extend in a handle direction between a proximal end and a distal end. The shaving cartridge 100 can be coupled with the distal end of the handle. In at least one example, the shaving cartridge 100 may be removably coupled with the handle, for example, by a lock and release mechanism. In other examples, the shaving cartridge 100 may be fixedly coupled with the handle such that the shaving cartridge 100 is not configured to be removably coupled with or selectively separated from the handle. The shaving cartridge 100 may be operable to pivot relative to the handle. In other examples, the shaving cartridge 100 may be secured to the handle in a fixed relationship such that the shaving cartridge 100 is not operable to pivot relative to the handle. The handle may be any suitable shape to allow a user to securely grip the handle. It is foreseen that the handle may include one continuous curve or include one straight portion or several curved and/or straight portions extending along an entirety of or a substantial portion of the handle without deviating from the scope of the present concept.

The shaving cartridge 100 includes a housing 101. The housing 101 extends along a longitudinal axis X-X. The housing 101, as illustrated, has a substantially rectangular shape, but may be any suitable shape such as ovoid or circular without deviating from the scope of the present concept. The shaving cartridge 100 and the housing 101 include a top side 110 and a bottom side 112 opposite the top side 110. The bottom side 112 is proximate to the handle, and the top side 110 includes at least one skin contacting area. The housing 101 includes a first second longitudinal wall 102, a first side wall 104 and a second side wall 106. The first longitudinal wall 102 extends longitudinally along the longitudinal axis X-X between the top and bottom sides 110, 112 and in a direction Z of the housing 101. In other examples, the first longitudinal wall 102 may form an angle with the axis in direction Z. The housing may further include a second longitudinal wall 103, arranged to extend substantially parallel to the first longitudinal wall. First and second side walls 104, 106 extend substantially parallel to each other from the first longitudinal walls 102 along a direction Y of the housing 101. In case the housing includes the second longitudinal wall 103, the first and second side walls may extend between the first and second longitudinal walls. The first and second side walls 104, 106 also extend between the top and bottom sides 110, 112 along the direction Z of the housing 101. The first and second side walls 104, 106 can extend along and substantially parallel to the direction Z of the housing 101, or form an angle with the axis in direction Z. The housing 101 may be made of plastic, metal, another suitable material, or any combination thereof without deviating from the scope of the present concept.

The shaving cartridge 100 includes a blade 116. In this example, the shaving cartridge further includes at least one component 109, however the exemplary shaving cartridge 100 of FIG. 1 shows a plurality of components 109 which assist and contribute to the shaving experience of the user. One of the components 109 is a plurality of blades 116 disposed and retained within the housing 101. The blades 116 extend along the longitudinal axis X-X. In at least one example, the shaving cartridge 100 can include one, two, three, four, or more of the blades 116 without deviating from the scope of the present concept. The blades 116 may be movably disposed or freely mounted, in the housing 101. For example, the blades 116 may be coupled with elastic means which extend from the housing 101. In other examples, the blades 116 may be fixedly disposed in the housing 101.

The components 109 of the shaving cartridge 100 may also include a cap 114 and a lubricating strip 115 included on and/or retained within the shaving cartridge 100. The cap 114 is coupled with the first longitudinal wall 102. The lubricating strip 115 is disposed on the top side 110 of the cap 114 to deliver a friction reduction effect, an anti-irritation effect, and/or provide lubrication after shaving. The lubrication means 115 can include any type of strip/member that provides a low-friction effect (for example, lubra strips, easy-glide strips, coatings with lubricious composition). The shaving cartridge 100 can also include a guard bar (not shown). The guard bar may be removable. The guard bar may also be omitted from the shaving cartridge 100. The guard bar may be coupled with the second longitudinal wall 103 opposite the cap 114 to stretch the skin during shaving or dispense the forces applied to the skin, thereby causing the shaving cartridge 100 to glide across the skin while providing a closer shave. The cap 114, the lubricating strip 115, and the guard bar each extend along the longitudinal axis X-X. Additional components, e.g., a cover and/or one or more trimming blades, may also be included on and retained within the shaving cartridge 100 without deviating from the scope of the present concept.

The shaving cartridge 100 can also include retaining means 1040, 1060 disposed in or on the first and second side walls 104, 106. The at least one of the components 109 are retained within or on the shaving cartridge 100 by retaining means 1040, 1060. For example, the retaining means 1040, 1060 are operable to retain the blades 116, the cap 114, the lubricating strip 115, and the guard bar on or within the shaving cartridge 100. The retaining means 1040, 1060 retain the components 109 by securely abutting and partially covering (i) a portion of the components, e.g., lateral sides or sides along the direction X of the components 109, and (ii) the side walls 104, 106. It is foreseen that the retaining means 1040, 1060 may be operable to secure one or more other components within or on the shaving cartridge 100 without deviating from the scope of the present concept. It is also foreseen that any one or more of the components 109 may be secured to the shaving cartridge 100 without the retaining means 1040, 1060, e.g., via other means, without deviating from the scope of the present concept. Suitable retaining means can be found in U.S. Pat. No. 9,539,734 and EP2853362, all incorporated herein by reference in their entirety. Further, the shaving cartridge 100 includes a customizing tool 200, as illustrated in FIGS. 1-12. The customizing tool 200 is coupled with the housing and arranged opposite to the first longitudinal wall 102. The customizing tool 200 expands the contact surface of the shaving cartridge 100 in two directions: (i) in parallel to the axis of the shaving plane, and (ii) perpendicularly to the axis of the shaving plane. Here, the axis of the shaving place is the axis along which the shaver is moved for performing shaving. For example, the axis of the shaving plane is substantially parallel to the axis Y shown in FIG. 1, which is perpendicular to the longitudinal axis. Thus, for example, the customizing tool 200 expands the contact surface of the shaving cartridge 100 in both directions defined by the axes X and Y.

The term “shaving plane” as used herein is intended to mean a tangent line that intersects the upper surface 202 of the customizing tool 200 and the cap 114. The customizing tool 200 provides customization as well as a better shaving experience. It can be understood by the skilled person that since the upper surface 202 of the customizing tool may include various customized solutions such as lubricating portions or fins or ribs, the shaving plane will be defined accordingly depending on the customized solution and therefore by the customizing tool.

Further, the term “blade exposure” as used herein is intended to mean the perpendicular distance from the cutting edge of a blade to the shaving plane. For a skilled person, the blade exposure is typically considered positive when the cutting edge of the blade is disposed above the shaving plane and is considered negative when the cutting edge is positioned below the shaving plane, measured when the shaving cartridge 100 is at rest position. It can be understood that the blades exposure will be defined according to the customized solution that will be applied onto the upper surface 202 of the customized tool 200. In detail, the user, depending on his needs and/or his skin profile, may choose the most suitable customized solution to achieve positive blades exposure for more aggressive shaving enhancing closeness or negative exposure for a smooth shaving with less nicks and cuts, thus succeeding the desired shaving performance.

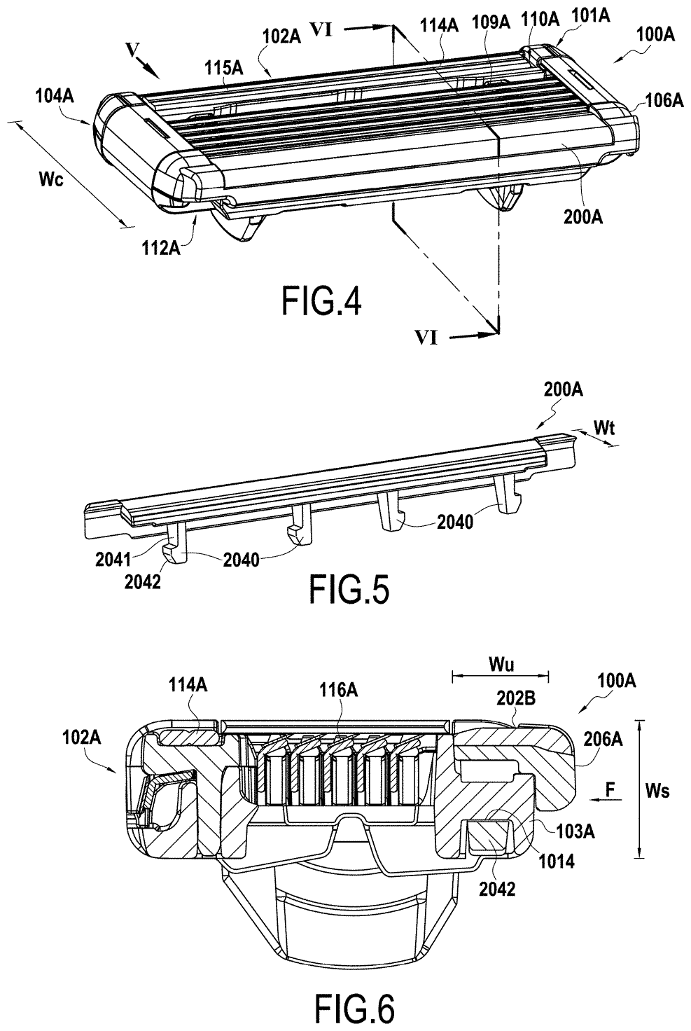

The customizing tool 200 includes an upper surface 202 that covers the position that, in conventional shaving cartridges, would be a guard bar. In other examples, the customizing tool 200 can be incorporated in addition to the guard bar, without covering the conventional position of the guard bar. In yet other examples, the customizing tool 200 can be incorporated in addition to the guard bar, while covering the guard bar. The upper surface 202 is parallel to the shaving plane and extends perpendicular to the longitudinal axis X-X external to the second longitudinal wall 103 of the housing 101.The upper surface 202 can be of any shape, for example a line, an arc, or a spline. The customizing tool 200 further includes a side surface 206 with lateral sides 212, 214 proximate to the external ends 108 of the first and second side walls 104, 106. In the exemplary shaving cartridge 100 of FIGS. 1-10, side surface 206 is perpendicular to the upper surface 202 and is opposite to the first longitudinal wall 102 of the housing 101 and external ends 108 of the first and second side walls 104, 106. The side surface may be of any shape, for example a line, an arc, or a spline. In FIGS. 1-3 and 7-9, the side surface 206/206B is perpendicular to the upper surface 202/202B and the width Wu of the upper surface 206/206B may be of the same or greater order as the width Ws of the side surface 202/202B. In FIGS. 4-6 and 10-12, the side surface 206A/206C is perpendicular to the upper surface 202A/202C, the width Wu of the upper surface 202A/202C being considerably greater than the width Ws of the side surface 206A/206C. In other examples, the side surface 206 may be at an angle with the upper surface 202. For example, the angle may be between about 10° and about 170°, alternatively between about 30° and about 150°, in particular, 40° to 120°. In case the housing includes the second longitudinal wall 103, the side surface 206 is proximate to the second longitudinal wall 103. The side surface 206 may form a second longitudinal wall of the assembly of the housing and the customizing tool, opposite to the first longitudinal wall 102 of the housing. Also, in case the second longitudinal wall 103 of the housing is provided, the side surface of the customizing tool 200 may cover or not the second longitudinal wall 103 of the housing, so that the second longitudinal wall of the assembly of the housing and the customizing tool, may be formed by the second longitudinal wall 103 of the housing or by the side surface 206 of the customizing tool. During shaving, the upper surface 202 of the customizing tool 200 stretches the skin. The side surface 206 further contributes by stretching and improves the ability of the shaving cartridge 100 to glide on the skin of a user in the contouring areas and in regions that are not easily treatable (for example, regions with bumps or not perfectly flat areas). Also, the stretched skin leads to less nicks and cuts and irritation effects. The width Wt of the customizing tool 200 can be between 0.5 mm and about 3 mm. The width Wu of the upper surface 202 of the customizing tool 200 can be between about 3 mm and about 6 mm. The width Ws of the side surface 206 of the customizing tool 200 can be between about 0.5 mm and about 7 mm. The customizing tool 200 can extend in the longitudinal direction at least as wide as the shaving cartridge 100. The customizing tool 200 can have a width Wt that spans both the first and second side walls 104, 106. It is also foreseen that the customizing tool 200 has a width Wt that is less than the width We of the shaving cartridge 100, so long as the customizing tool 200 provides skin stretching and gliding attributes. The width Wt of the customizing tool and the width Wu of the upper surface are measured considering the axis of the shaving plane along which the shaver is moved to perform shaving. The width Ws of the side surface is measured considering the axis, perpendicular to the axis of the shaving plane. The width Wu of the upper surface of the customizing tool 200 may be greater than the width Ws of the side surface, because the upper surface improves shaving performance mainly and the side surface functions synergistically as supporting part to allow the razor to contact the skin smoothly. The customizing tool 200 provides a larger footprint on the skin, such that the skin and hair contacts with the shaving cartridge 100 over a wider surface during each shaving stroke. Accordingly, less repeated strokes are required by the user and the overall shaving process becomes easier and faster.

An upper curved surface 204 connects the upper surface 202 and the side surface 206. The upper curved surface 204 may have a curvature which may correspond with a substantially circular shape with a radius. The radius of the upper curved surface 204 can be between about 0.1 mm and about 30 mm, alternatively between about 0.1 mm and about 20 mm, in particular 0.1 mm to 10 mm. It is foreseen that the upper curved surface 204 may be polygonal, have a smooth curvature, or any other suitable configuration to connect the upper surface 202 with the side surface 206 without deviating from the present concept.

The customizing tool 200 also has a lower surface 210 which is proximate to the bottom side 112 of the shaving cartridge 100. The lower surface 210 may be flat and substantially parallel to the upper surface 202. In other embodiments of the present concept, the lower surface 210 may be curved, or any other suitable or desired shape. The customizing tool 200 also has an internal surface 213 at the lower surface 210 where the side surface 206 extends when the customizing tool surrounds the bottom of the housing. A lower curved surface 208 connects the side surface 206 with the lower surface 210. The lower curved surface 208 may have a curvature which may correspond with a substantially circular shape with a radius. The radius of the lower curved surface 208 can be between about 0.1 mm and about 30 mm, alternatively between about 0.1 mm and about 20 mm, in particular 0.1 mm to 10 mm. It is foreseen that the lower curved surface 208 may be polygonal, have a smooth curvature, or any other suitable configuration to connect the lower surface 210 with the side surface 206 without deviating from the present concept. The lower curved surface 208 and the upper curved surface 204 may have the same curvature. In other embodiments of the present concept, as illustrated in FIG. 3, the lower curved surface 208 and the upper curved surface 204 may have different curvatures with different radii, such that the ability to glide may be adjusted as desired.

The surfaces of the customizing tool 200, for example the upper surface 202, upper curved surface 204, side surface 206, lower curved surface 208, and lower surface 210, are homogenous without patterns, such as protrusions or fingers. In other examples, the surfaces of the customizing tool can bear configurations, for example ribs, fins, filaments, or protrusions, which can be made of various materials. Also, the configurations of the upper surface 202 may differ from those of the side surface 206 or the lower surface 210. In at least one embodiment of the present concept, the customizing tool 200 can include lubricating portions, for example lubra strips, or a co-injected lubra layer on the upper surface 202. At least a portion of the customizing tool 200 is made of at least one of metal, plastic, and rubber. For example, the surfaces of the customizing tool 200 may include metal, plastic, rubber, wood, paper, glass, or a combination thereof. Further, the surfaces of the customizing tool 200 can include at least one coating to provide attributes including, but not limited to, anti-corrosion effect, lubricity and glide effect, anti-irritation effect, anti-bacterial effect, or any other desired attribute. The customizing tool 200 can also include clay, which may provide exfoliation or peeling. In yet other examples, the customizing tool 200 can include a TPE material and water-soluble ingredients, which act as lubricants or contain hair-skin preparation features. In at least one embodiment of the present concept, the side surface 206 of the customizing tool 200 can be a porous material or a sponge, where shaving aid can be absorbed. It is foreseen that the customizing tool 200 may include any other desired or suitable material or combination thereof without deviating from the present concept. In one example, the customizing tool 200 can be immersed in a water bath such that the surfaces can be wet and cooled or warm before shaving. The configuration of the customizing tool 200 with the upper surface 202, the upper curved surface 204, the side surface 206, the lower curved surface 208 and the lower surface 210 may form a substantially C-shaped component which can be made of any material from the aforementioned. In other examples, the customizing tool 200 can be a flat component where only the upper surface 202 is provided and slightly extended in the direction of the shaving plane.

The customizing tool 200 can be coupled with the shaving cartridge 100 such that a user could not easily or conveniently remove the customizing tool 200. In other embodiments of the present concept, the customizing tool 200 can be removably coupled with the shaving cartridge 100 such that the customizing tool 200 can be removed and re-attached. If removed, a guard bar may be placed on the shaving cartridge 100. In another example, if the customizing tool 200 is removed, the shaving cartridge 100 may have a vacant recess configured to receive the customizing tool 200. The vacant recess may be filled with, for example, a shaving aid (e.g., foam, gel). Accordingly, a removable customizing tool 200 provides customization options for a user.

The customizing tool 200 is coupled with the housing 101 by at least one of a snap fit mechanism, a hook mechanism, a press fit mechanism, a twist mechanism, a screw mechanism, any other suitable mechanism such as ultrasonic welding or gluing, or a combination thereof. As illustrated on FIGS. 2 and 3, the bottom side 203 of the upper surface 202 of the customizing tool 200 includes at least one protrusion 2030 which corresponds with recesses 1012 in the top side 110 of the second longitudinal wall 103 to couple the customizing tool 200 with the housing 101. The coupling of the customizing tool 200 with the housing 101 may be achieved through protrusions provided at any position of the customizing tool 200 and/or through protrusions provided on the housing to fill any corresponding recesses on the customizing tool 200. The at least one protrusion 2030 extends along the longitudinal axis X-X. The at least one protrusion 2030 also extends from the bottom side 203 of the upper surface 202 in the Z direction. Further, the top side 211 of the lower surface 210 includes two protrusions 2110 which correspond with recesses 1010 in the bottom side 112 of the second longitudinal wall 103 to couple the customizing tool 200 with the housing 101. In other embodiments of the present concept, the customizing tool 200 can have one, two, or more than two protrusions 2110, as desired. It is foreseen that the at least one protrusion 2030 and the at least one protrusion 2110 can be any suitable shape or configuration without deviating from the present concept, so long as the customizing tool 200 is coupled with the housing 101 of the shaving cartridge 100. For example, the housing may have either protrusions or recesses to be coupled with the corresponding recesses or protrusions of the customizing tool and vice versa. The lower surface 210 may also include one or more cutouts 2111 for improved fitting of the customizing tool to the housing 101. Accordingly, when coupled to the shaving cartridge 100, the bottom side 203 of the upper surface 202 is proximate to or abuts the top side 110 of the housing, the inner side 207 of the side wall 206 is proximate to or abuts the external ends 108 of the first and second side walls 104, 106 and/or the external side 113 of the second longitudinal wall 103, and the top side 211 of the lower surface 210 is proximate to or abuts the bottom side 112 of the second longitudinal wall 103.

In further embodiments, the coupling of the customizing tool may be achieved with at least one hook provided on the bottom side of the upper surface of the customizing tool and through corresponding recesses on the housing that receive the at least one hook of the customizing tool.

In FIGS. 4-6, the customizing tool 200A is coupled with the housing 101A by hooks 2040 protruding on the bottom side of the customizing tool. Each of these hooks 2040 may include a stem 2041 arranged essentially perpendicular to the shaving plane and a head 2042 for hooking on a retaining portion 1014 formed on the housing, at a distance from the upper face thereof. One of more hooks 2040 may be provided, for example two hooks disposed symmetrically or, as shown, two pairs of hooks arranged symmetrically with respect to a middle transverse plane of the customizing tool (corresponding to the section place VI-VI). Other numbers or arrangements of hooks may be provided. In this example, the heads 2042 of the hooks 2040 face laterally towards the outside that is opposite to a middle transverse plane of the customizing tool. The retaining portions 1014 may be formed on the edges of windows or similar formed in a wall portion of the housing, at a distance from the upper face, substantially in parallel with the shaving plane. In this example, these retaining edges extend substantially perpendicular to the longitudinal direction X and substantially parallel to the shaving plane. As mentioned, the side surface 206A of the customizing tool 200A has a width Ws lower than the width Wu of the upper surface 202A. As a matter of fact, seen from arrow F parallel to the shaving plane, the side surface 206A does not cover the whole of the width (measured perpendicular to the shaving plane) of the longitudinal wall 103A of the housing 101A. However, other arrangements are possible, and the width Ws may be larger, in particular be of the same magnitude as the width Wu or more, in particular cover the whole width of the longitudinal wall 103A.

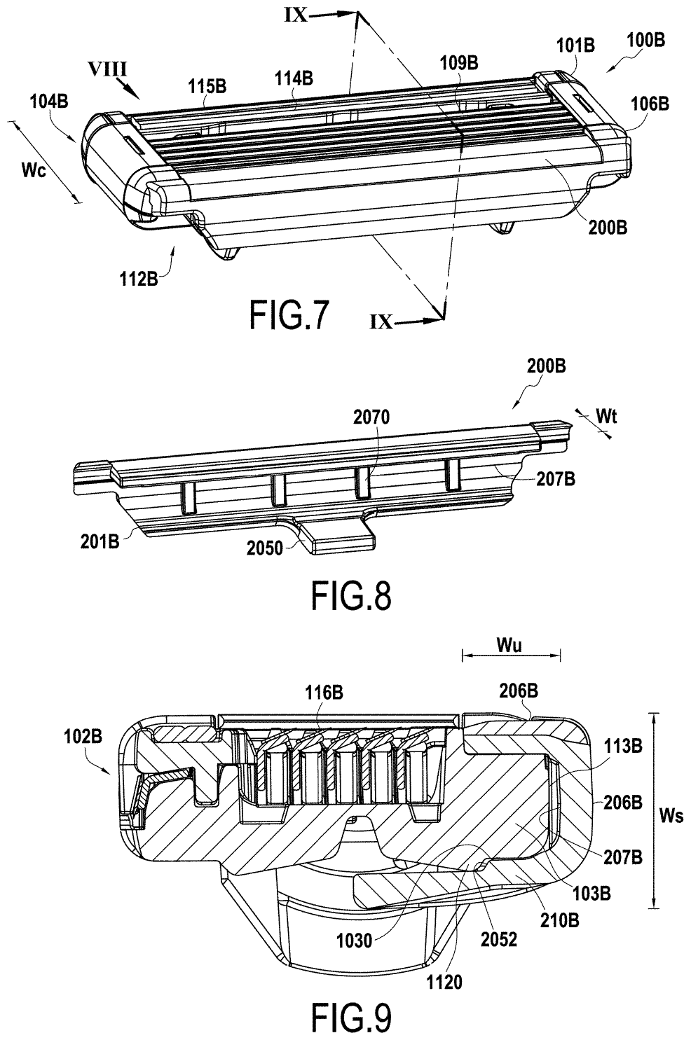

In FIGS. 7-9, the customizing tool 200B is coupled with the housing 101B by at least one hook 2050 formed as an extension of the lower surface 210B. Thus, seen in transverse section as in FIG. 9, this hook 2050 embraces the longitudinal wall 103A. In this example, the side surface 206B of the customizing tool 200B covers the longitudinal wall 103 at least for a portion of the length thereof. The inner side 207B of the side wall 206B is proximate to or abuts the external side 113B of the longitudinal wall 103B. The inner side 207B of the side wall 206B may be provided with spacers 2070, including ribs, projections of similar, contacting the external side 113B of the longitudinal wall 103B. The hook 2050 is connected to the lower surface 210B of the customizing tool 200B via an indent 2052 formed on the inner side (facing upwards) of the lower surface 210B. This indent acts as a wedging element, abutting against a wedging surface 1030 of the longitudinal wall 103B at the bottom side 112B of the customizing tool. Other wedging arrangements may be provided. The wedging surface 1030 is formed on an outer side of a convex portion 1120 of the bottom side of the customizing tool 200B. The hook 2050 may have a shape providing snap-fitting engagement with the convex portion 1120.

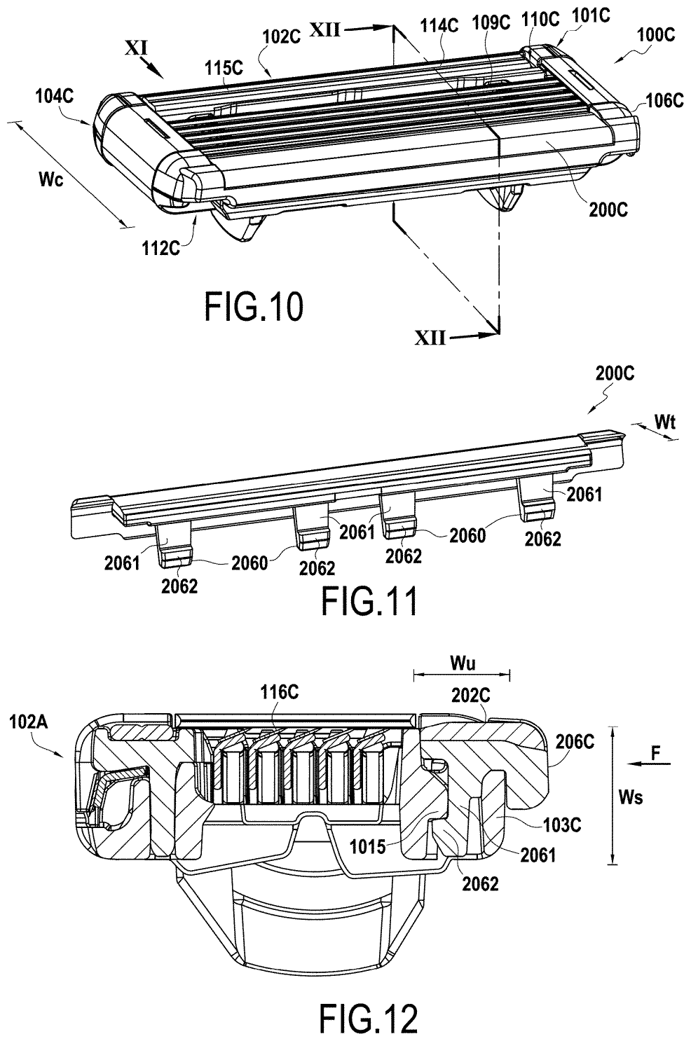

In FIGS. 10-12, the customizing tool 200C is coupled with the housing 101C by 2060 protruding on the bottom side of the customizing tool. Each of these hooks 2060 may include a stem 2061 arranged essentially perpendicular to the shaving plane and a head 2062 for hooking on a retaining portion 1015 formed on the housing, at a distance from the upper face thereof. One of more hooks 2060 may be provided, for example two hooks disposed symmetrically or, as shown, two pairs of hooks arranged symmetrically with respect to a middle transverse plane. Other numbers or arrangements of hooks may be provided. In this example, the heads 2062 of the hooks 2060 face opposite the outer side of the side surface 206C, that is towards a central part of the housing, where the blades 116C are arranged. The retaining portions 1015 may be formed on the edges of at least one window or similar formed in a wall portion of the housing, at a distance from the upper face, substantially in parallel with the shaving plane. In this example, these retaining edges extend substantially parallel to the longitudinal direction X, and substantially parallel to the shaving plane. While a window may be provided for each hook, it is also possible to provide less windows, for example one window having a continuous retaining edge for the hooks. As mentioned, the side surface 206C of the customizing tool 200C has a width Ws lower than the width Wu of the upper surface 202C. As a matter of fact, seen from arrow F parallel to the shaving plane, the side surface 206C does not cover the whole of the width (measured perpendicular to the shaving plane) of the longitudinal wall 103C of the housing 101C. However, other arrangements are possible, and the width Ws may be larger, in particular be of the same magnitude as the width Wu or more, in particular cover the whole width of the longitudinal wall 103C.

It will be appreciated by those skilled in the art that changes could be made to the embodiments described above without departing from the broad concept thereof. It is understood, therefore, that the present concept disclosed herein is not limited to the particular embodiments disclosed and is intended to cover modifications within the spirit and scope of the present concept.

1.-14. (canceled)

15. A shaving cartridge comprising:
a housing extending along a longitudinal axis, the housing having
a top side;
a bottom side opposite to the top side; and
at least one longitudinal wall;
a first side wall and a second side wall extending from the at least one longitudinal wall;
a guard bar removably coupled with the housing;
a customizing tool; and
at least one shaving blade disposed in the housing and extending along the longitudinal axis between the first and second side walls;
the customizing tool including
an upper surface; and
a side surface which extends at an angle from this upper surface, the customizing tool extending along the at least one longitudinal wall and being removably coupled with the housing so as to be interchangeable with the guard bar.

16. The shaving cartridge according to claim 15, wherein the customizing tool further includes a lower surface which is proximate to the bottom side of the at least one longitudinal wall.

17. The shaving cartridge according to claim 16,
wherein the lower surface includes at least one protrusion which corresponds with a recess formed in the bottom side of the at least one longitudinal wall; and
wherein the at least one protrusion and the recess being configured to couple the customizing tool with the housing.

18. The shaving cartridge according to claim 15, wherein the upper surface and the side surface include ribs, fins, filaments, lubrication coating, and/or protrusions.

19. The shaving cartridge according to claim 16, wherein the lower surface includes ribs, fins, filaments, lubrication coating, and/or protrusions.

20. The shaving cartridge according to claim 15, wherein the customizing tool is coupled with the housing by at least one of a snap fit mechanism, a hook mechanism, a press fit mechanism, a twist mechanism, and a screw mechanism.

21. The shaving cartridge according to claim 15, wherein
the upper surface of the customizing tool includes at least one protrusion which corresponds with a recess formed in the top surface of the at least one longitudinal wall; and
the at least one protrusion and the recess are configured to couple the customizing tool with the housing.

22. The shaving cartridge according to claim 15, wherein
the upper surface of the customizing tool has a width of 3 mm to 6 mm; and
the side surface of the customizing tool has a width of 0.5 mm to 7 mm.

23. The shaving cartridge according to claim 15, wherein the upper surface and the side surface are homogenous and without patterns.

24. The shaving cartridge according to claim 15, wherein the upper surface of the customizing tool includes lubricating portions.

25. The shaving cartridge according to claim 15, wherein the side surface of the customizing tool includes a porous material.

26. The shaving cartridge according to claim 15, wherein at least a portion of the customizing tool is made of at least one of the materials consisting of metal, plastic, rubber, wood, paper, and glass.
